(19) United States
(12) Patent Application Publication
(10) Pub. No.: US 2026/0065036 A1
(43) Pub. Date: Mar. 5, 2026

(54) METHOD, APPARATUS, DEVICE, AND STORAGE MEDIUM FOR TRAINING GENERATIVE MODEL

(71) Applicants: Beijing Zitiao Network Technology Co., Ltd., Haidian District (CN); Lemon Inc., Grand Cayman (KY)

(72) Inventors: Yaojie Shen, Beijing (CN); Xinyao Wang, Los Angeles, CA (US); Yulei Niu, Los Angeles, CA (US); Ying Zhou, Beijing (CN); Lexin Tang, Los Angeles, CA (US); Fan Chen, Los Angeles, CA (US); Longyin Wen, Los Angeles, CA (US)

(21) Appl. No.: 19/318,024

(22) Filed: Sep. 3, 2025

(30) Foreign Application Priority Data
Sep. 3, 2024 (CN) 202411230895.8

(51) Int. Cl. G06N 3/0475; G06F 40/40

(52) U.S. Cl. CPC G06N 3/0475; G06F 40/40

(57) ABSTRACT

Embodiments of the disclosure relate to a method, an apparatus, a device, and a computer-readable storage medium for training a generative model. The method includes: constructing a training prompt; and performing a plurality of rounds of iterative training based on the training prompt, wherein each round of iterative training includes: obtaining a plurality of response contents generated by the generative model based on the training prompt; determining a first response content and a second response content from the plurality of response contents based on evaluation information of the plurality of response contents, wherein an evaluation of the first response content is superior to an evaluation of the second response content; and adjusting a parameter of the generative model to increase a first probability of outputting the first response content and reduce a second probability of outputting the second response content.

### CROSS-REFERENCE

The present application claims priority to Chinese Patent Application No. 202411230895.8, filed on Sep. 3, 2024 and entitled “METHOD, APPARATUS, DEVICE, AND STORAGE MEDIUM FOR TRAINING GENERATIVE MODEL”, the entirety of which is incorporated herein by reference.

### FIELD

Example embodiments of the present disclosure generally relate to the field of computers, and in particular, to a method, an apparatus, a device, and a computer-readable storage medium for training a generative model.

### BACKGROUND

With the development of computer technologies, generative models have been widely applied to the generation of various modal contents. For example, a language model can generate a corresponding response based on an input prompt. Therefore, the training quality of the generative model directly affects the quality of the generative result.

### SUMMARY

In a first aspect of the present disclosure, a method for training a generative model is provided. The method comprises: constructing a training prompt; and performing a plurality of rounds of iterative training based on the training prompt, wherein each round of iterative training comprises: obtaining a plurality of response contents generated by the generative model based on the training prompt; determining a first response content and a second response content from the plurality of response contents based on evaluation information of the plurality of response contents, wherein an evaluation of the first response content is superior to an evaluation of the second response content; and adjusting a parameter of the generative model to increase a first probability of outputting the first response content and reduce a second probability of outputting the second response content.

In a second aspect of the present disclosure, an apparatus for training a generative model is provided. The apparatus comprises a constructing module configured to construct a training prompt; and a training module configured to perform a plurality of rounds of iterative training based on the training prompt, wherein each round of iterative training comprises: obtaining a plurality of response contents generated by the generative model based on the training prompt; determining a first response content and a second response content from the plurality of response contents based on evaluation information of the plurality of response contents, wherein the evaluation of the first response content is superior to an evaluation of the second response content; and adjusting parameters of the generative model to increase a first probability of outputting the first response content and reduce a second probability of outputting the second response content.

In a third aspect of the present disclosure, an electronic device is provided. The device comprises at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium stores a computer program, and the computer program is executable by the processor to perform the method of the first aspect.

It should be understood that the content described in the summary is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in combination with the accompanying drawings. In the drawings, the same or similar reference numbers refer to the same or similar elements, wherein:

FIG. 1 illustrates a schematic diagram of an example environment in which embodiments according to the present disclosure may be implemented;

FIG. 2 illustrates a flowchart of an example process of training a generative model according to some embodiments of the present disclosure;

FIG. 3 illustrates pseudo code of an iterative training process according to some embodiments of the present disclosure;

FIG. 4 illustrates a schematic structural block diagram of an example apparatus for training a generative model according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “comprising” and the like should be understood as open inclusion, that is “comprising but not limited to”. The term “based on” should be understood as “at least partially based on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related provisions. In the embodiments of the present disclosure, all data is collected, obtained, processed, refined, forwarded, used, or the like on the premise that the user knows and confirms. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

If the solutions in the present specification and the embodiments involve personal information processing, all of which will be performed on the premise of having a legality basis (for example, obtaining consent of a personal information subject, or necessary for performing a fulfillment contract), and processed only within a specified or agreed range. If a user refuses to provide personal information other than the necessary information required by the basic function, the usage of the basic function would not be affected.

The training quality of the generative model directly affects the quality of the generation result of the model. In the process of training the generative model, a traditional preference optimization process requires a large amount of manual annotation data, which greatly increases the training cost of the generative model.

Embodiments of the present disclosure provide a solution for training a generative model. According to this solution, a training prompt may be constructed. Further, a plurality of rounds of iterative training may be performed based on the training prompt.

Specifically, each round of iterative training may comprise: obtaining a plurality of response contents generated by the generative model based on the training prompt; determining a first response content and a second response content from the plurality of response contents based on evaluation information of the plurality of response contents, wherein an evaluation of the first response content is superior to an evaluation of the second response content; and adjusting a parameter of the generative model to increase a first probability of outputting the first response content and reduce a second probability of outputting the second response content.

By performing the plurality of rounds of iterative training based on the training prompt, the embodiments of the present disclosure can not only improve the data utilization efficiency and reduce the training cost, but also improve the stability of the training process.

Various example implementations of this solution are described in detail below in combination with the accompanying drawings.

### Example Environment

FIG. 1 illustrates a schematic diagram of an example environment 100 in which embodiments of the present disclosure can be implemented. As shown in FIG. 1, the example environment 100 may include an electronic device 110.

In the example environment 100, the electronic device 110 may obtain a training prompt 120, and may perform the plurality of rounds of iterative training on a generative model 120 based on the training prompt. In some embodiments, the training prompt 120 may be synthesized by an algorithm to reduce the cost of constructing the training prompt.

In some embodiments, the generative model 120 may automatically generate a content such as text, an image, music, and the like according to the learned data. As an example, the generative model 120 may comprise a language model that may generate a corresponding textual content based on the input prompt.

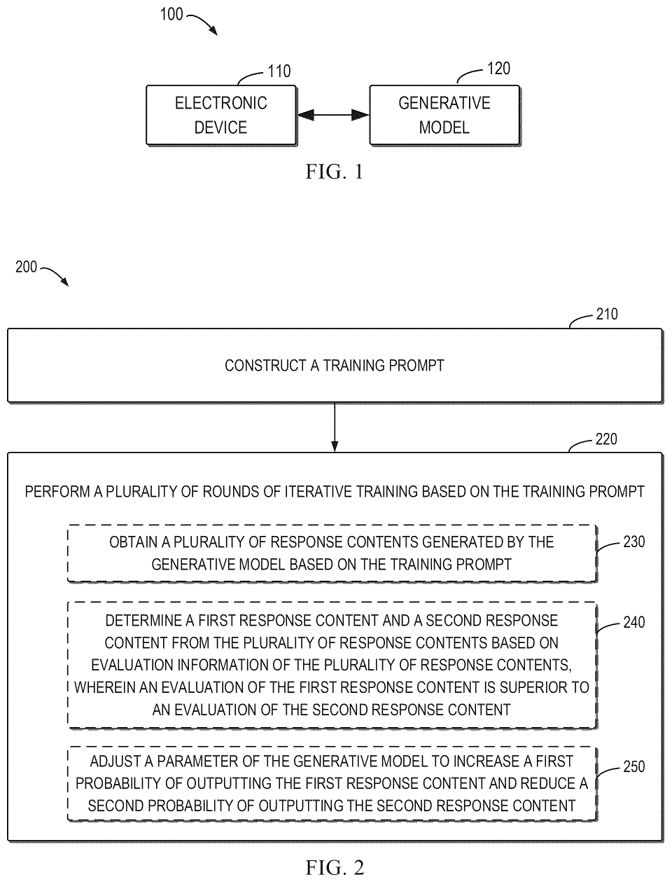

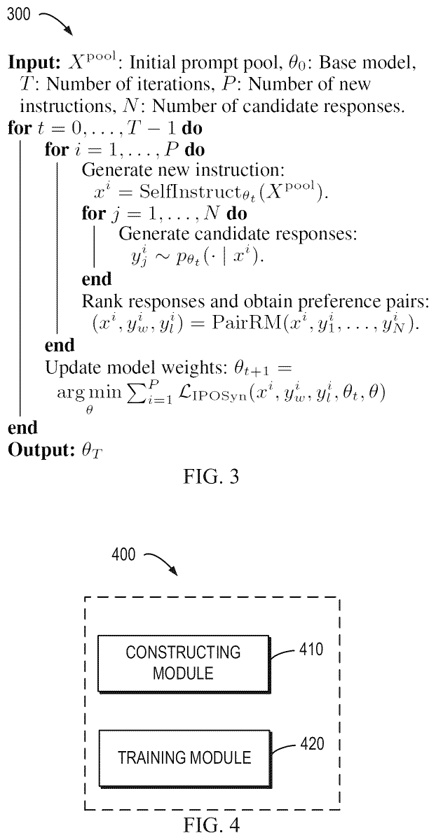

A specific training process with respect to the generative model 120 will be described in detail below with reference to FIGS. 2 and 3.

The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, and so on).

The electronic device 110 may also be a standalone physical server, or may be a server cluster or a distributed system composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The electronic device 110 may include, for example, a computing system/server, such as a mainframe, an edge computing node, a computing device in a cloud environment, or the like.

It should be understood that the structures and functions of the various elements in the environment 100 are described for example purposes only and do not imply any limitation to the scope of the present disclosure.

Some example embodiments of the present disclosure will be described below with continued reference to the accompanying drawings.

### Example Process

FIG. 2 illustrates a flowchart of an example process 200 of training a generative model according to some embodiments of the present disclosure. The process 200 may be implemented at the electronic device 110. The process 200 is described below with reference to FIG. 1.

As shown, at block 210, the electronic device 110 constructs a training prompt.

In some embodiments, as discussed with reference to FIG. 1, the training prompt may be synthesized using a generative model. As an example, the electronic device 110 may utilize a self-instruct technique to synthesize the training prompt. As an example, the training device utilizes a language model to generate instructions similar to instructions written by human. By using the synthetic instruction, embodiments of the present disclosure may reduce the construction cost of the training data.

In some embodiments, the training prompt may be generated by a generative model to be trained. It has been found through experimentation that training with the synthetic instruction and response generated by the current model may yield optimal performance, which is competitive in performance as compared to instructions written by human.

With continued reference to FIG. 2, at block 220, the electronic device 110 performs a plurality of rounds of iterative training based on the training prompt. In some embodiments, the electronic device 110 may perform a predetermined number of rounds of iterations.

In particular, blocks 230 to 250 illustrate example processes trained at each round of iteration. As shown in FIG. 2, at block 230, the electronic device 110 obtains a plurality of response contents generated by the generative model based on the training prompt.

A specific process of iterative training will be described below with reference to FIG. 3, which shows pseudo code of an iterative training process according to some embodiments of the present disclosure.

As shown in FIG. 3, the electronic device 110 may perform T rounds of iterative training. During each round of iterative training, the electronic device 110 may obtain a plurality of new instructions xⁱ (that is, training prompts).

Further, the electronic device 110 may generate N response contents

$${y}_{j}^{i}$$

(also referred to as candidate responses) based on the training prompt xⁱ.

With continued reference to FIG. 2, at block 240, the electronic device 110 determines a first response content and a second response content from the plurality of response contents based on evaluation information of the plurality of response contents, where an evaluation of the first response content is superior to an evaluation of the second response content.

In some embodiments, the electronic device 110 may utilize a suitable evaluation model to evaluate the plurality of response contents output by the generative model. As an example, the electronic device 110 may evaluate the plurality of response contents

$${y}_{j}^{i}$$

by using a pairwise response model (PairPM).

Specifically, the electronic device 110 may rank the plurality of response contents based on the evaluation information. Further, the electronic device 110 may determine the first response content and the second response content based on a ranking result of the plurality of response contents.

Taking FIG. 3 as an example, the electronic device 110 may utilize PairPM to determine the first response content

$${y}_{w}^{i}$$

and the second response content

$${y}_{l}^{i}$$

from the plurality of response contents. In some examples, the first response content

$${y}_{w}^{i}$$

may be a response content with a best evaluation in the plurality of response contents, and the second response content

$${y}_{l}^{i}$$

may be a response content with a worst evaluation in the plurality of response contents.

In some scenarios, the first response content

$${y}_{w}^{i}$$

may further be referred to as an accepted response content, and the second response content

$${y}_{l}^{i}$$

may further be referred to as a rejected response content.

With continued reference to FIG. 2, at block 250, the electronic device 110 adjusts a parameter of the generative model to increase a first probability of outputting the first response content and reduce a second probability of outputting the second response content.

Specifically, as shown in FIG. 3, the electronic device 110 may iteratively adjust the parameter of the generative model by minimizing the following loss function:

$$arg {min}_{θ} {\sum }_{i = 1}^{P} {ℒ}_{IPOSyn} ( {x}^{i} , {y}_{w}^{i} , {y}_{l}^{i} , {θ}_{t} , θ ) \qquad ( 1 )$$

The specific determining process of the loss function

$${ℒ}_{IPOSyn} ( {x}^{i} , {y}_{w}^{i} , {y}_{l}^{i} , {θ}_{t} , θ )$$

will be further described below.

Conventionally, a loss function based on preference optimization may be expressed as:

$$( 2 )$$

$${ℒ}_{D P O} \text{} ( {π}_{θ} ; {π}_{r e f} ) = - {𝔼 \text{}}_{( x , {y}_{w ,} {y}_{l} ) ∼ 𝒟} [ log σ ( βlog \frac{{π}_{θ} ( {y}_{w} \vert x )}{{π}_{θ} ( {y}_{l} \vert x )} - βlog \frac{{π}_{ref} ( {y}_{w} \vert x )}{{π}_{ref} ( {y}_{l} \vert x )} ]$$

$$log \frac{{π}_{θ} ( {y}_{w} \vert x )}{{π}_{θ} ( {y}_{l} \vert x )}$$

represents first preference information of the generative model to be trained, which is determined based on a ratio of the first probability of the generative model selecting a better response content y_{w} (that is, the first response content) to the second probability of the generative model selecting a worse response content yₗ (that is, the second response content).

$$log \frac{{π}_{ref} ( {y}_{w} \vert x )}{{π}_{ref} ( {y}_{l} \vert x )}$$

represents second preference information of the reference model to be trained, which is determined based on a ratio of a third probability of the generative model selecting a better response content y_{w} (that is, the first response content) to a fourth probability of the generative model selecting a worse response content yₗ (that is, the second response content).

In some embodiments, the reference model may correspond to an initial parameter of the generative model before the plurality of rounds of iterative training.

In addition, experiments show that the iterative training further improves performance on synthetic data, but also exacerbates the utilization of a response length. In the iterative training process, although the performance of the model on the benchmark is improved, the response length is significantly increased, which may affect the utility of the model and the accuracy of evaluating the benchmark.

Further, the embodiment of the present disclosure optimizes the training function of Equation (2) to be expressed as Equation (3):

$${∇}_{θ} {ℒ}_{α - DPO} ( {π}_{θ} ; \text{} \text{} {π}_{r e f} ) = - \text{} β \text{} {𝔼}_{( x {y}_{w ,} {y}_{l} ) ∼ 𝒟} \text{} [ \text{} {w}_{θ} \cdot ( {∇}_{θ} log π ( {y}_{w} \vert x ) - {∇}_{θ} log π ( {y}_{l} \vert x ) ) ] \qquad ( 3 )$$

$$where$$

$$\begin{matrix}{w}_{θ} = σ ( β ( ( 1 - α ) \cdot {s}_{ref} - {s}_{θ} ) ) \\ = σ ( β ( {s}_{ref} - {s}_{θ} - α \cdot {s}_{ref} ) )\end{matrix} \qquad ( 4 )$$

$${s}_{θ} = log \frac{{π}_{θ} ( {y}_{w} \vert x )}{{π}_{θ} ( {y}_{l} \vert x )} \qquad ( 5 )$$

$${s}_{ref} = log \frac{{π}_{ref} ( {y}_{w} \vert x )}{{π}_{ref} ( {y}_{l} \vert x )} \qquad ( 6 )$$

Specifically, Equation (5) represents a process of determining the first preference information s_{θ}; Equation (6) represents a process of determining the second preference information s_{ref}.

As shown in Equation (4), the electronic device 110 may determine difference information s_{ref}−s₀ based on a difference between the first preference information so and the second preference information s_{ref}. In addition, the electronic device 110 may further apply a predetermined weight coefficient α to the second preference information s_{ref} to determine third preference information α·s_{ref}. As an example, a may be greater than 0.

Therefore, the electronic device 110 may determine an objective loss based on the difference information s_{ref}−s_{θ} and the third preference information α·s_{ref} according to Equation (3).

Experimental results show that by introducing the weight coefficient related to the second preference information, the embodiments of the present disclosure can effectively improve the performance of the model on multiple benchmark tests, and meanwhile, the growth of the response length is controlled.

In the process of iterative training, responses generated by the model may become increasingly similar, making it more difficult to distinguish between a preferred response and a non-preferred response. By adding a weight coefficient related to the prediction difficulty of the reference model, the embodiments of the present disclosure can assign higher learning weights to pairs of responses that are difficult to distinguish, that is, hard examples. This causes the model to be more focused on these hard examples in the training process, thereby improving the discrimination capability of the model.

In addition, for those pairs of responses that those reference models can already easily distinguish, the embodiments of the present disclosure adjust the weight coefficient to reduce excessive attention to the easy examples. This relaxation helps avoid the model from wasting excessive learning resources on these obvious cases, making the training process more efficient.

In some embodiments, the loss function shown in Equation (1) may also consider a negative log-likelihood loss listed in Equation (7), and may ultimately be expressed as Equation (8).

$${ℒ}_{N L L} = - \frac{1}{\vert {y}_{w} \vert} log ( {π}_{θ} ( {y}_{w} \vert x ) ) \qquad ( 7 )$$

$${ℒ}_{IPOSyn} = {ℒ}_{α - DPO} + λ \cdot {ℒ}_{N L L} \qquad ( 8 )$$

where λ is a weight coefficient.

Based on the above process, the embodiments of the present disclosure can not only improve the utilization efficiency of data and reduce the training cost, but also improve the stability of the training process.

### Example Apparatus and Device

The embodiments of the present disclosure also provide a corresponding apparatus for implementing the above method or process. FIG. 4 is a schematic structural block diagram of an example apparatus 500 for training a generative model according to some embodiments of the present disclosure. The apparatus 400 may be implemented or included in the electronic device 110. The various modules/components in the apparatus 400 may be implemented by hardware, software, firmware, or any combination thereof.

As shown in FIG. 4, the apparatus 400 comprises a constructing module 410 configured to construct a training prompt; and a training module 420 configured to perform a plurality of rounds of iterative training based on the training prompt. Specifically, each round of iterative training comprises: obtaining a plurality of response contents generated by the generative model based on the training prompt; determining a first response content and a second response content from the plurality of response contents based on evaluation information of the plurality of response contents, wherein the evaluation of the first response content is superior to an evaluation of the second response content; and adjusting parameters of the generative model to increase a first probability of outputting the first response content and reduce a second probability of outputting the second response content.

In some embodiments, the constructing module 410 is further configured to generate the training prompt using the generative model.

In some embodiments, the training module 420 is further configured to rank the plurality of response contents based on the evaluation information; and determine the first response content and the second response content based on a ranking result of the plurality of response contents.

In some embodiments, the first response content is a response content with a best evaluation in the plurality of response contents, and the second response content is a response content with a worst evaluation in the plurality of response contents.

In some embodiments, the training module 420 is further configured to determine first preference information of the generative model based on the first probability and the second probability; determine second preference information of a reference model based on a third probability of the reference model outputting the first response content and a fourth probability of the reference model outputting the second response content; and determine an objective loss based on the first preference information and the second preference information, to adjust the parameter of the generative model.

In some embodiments, the training module 420 is further configured to determine difference information based on a difference between the first preference information and the second preference information; apply a predetermined weight coefficient to the second preference information to determine third preference information; and determine the objective loss based on the difference information and the third preference information.

In some embodiments, a parameter of the reference model corresponds to an initial parameter of the generative model prior to the plurality of rounds of iterative training.

In some embodiments, the generative model is a language model and the plurality of response contents are text contents.

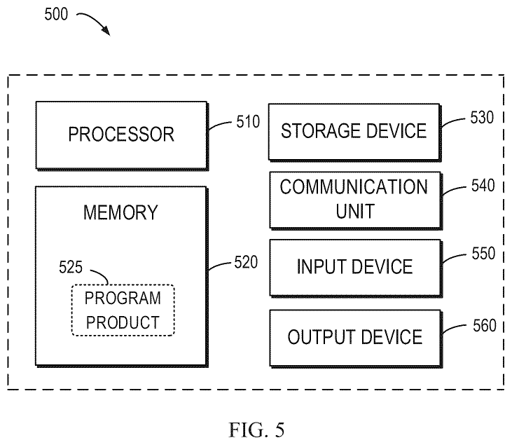

FIG. 5 illustrates a block diagram of an electronic device 500 in which one or more embodiments of the present disclosure may be implemented. It should be understood that the electronic device 500 illustrated in FIG. 5 is merely exemplary and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processor 510 may be an actual or virtual processor and capable of performing various processes according to programs stored in the memory 520. In multiprocessor systems, multiple processing units execute computer-executable instructions in parallel to improve the parallel processing capabilities of the electronic device 500.

The electronic device 500 typically includes a plurality of computer storage media. Such media may be any available media accessible to the electronic device 500, including, but not limited to, volatile and non-volatile media, removable and non-removable media. The memory 520 may be a volatile memory (for example, a register, a cache, a random access memory (RAM)), a non-volatile memory (for example, a read-only memory (ROM), an electrically erasable programmable read-only memory (EEPROM), a flash memory), or some combination thereof. The storage device 530 may be a removable or non-removable medium and may include a machine-readable medium, such as a flash drive, a magnetic disk, or any other medium, which may be capable of storing information and/or data and may be accessed within the electronic device 500.

The electronic device 500 may further include additional removable/non-removable, volatile/non-volatile storage media. Although not shown in FIG. 5, a disk drive for reading or writing from a removable, non-volatile magnetic disk (for example, a “floppy disk”) and an optical disk drive for reading or writing from a removable, non-volatile optical disk may be provided. In these cases, each drive may be connected to a bus (not shown) by one or more data medium interfaces. The memory 520 may include a computer program product 525 having one or more program modules configured to perform various methods or operations of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, and so on, communicate with one or more devices that enable a user to interact with the electronic device 500, or communicate with any device (for example, a network card, a modem, and so on) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, where the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer-readable program instructions.

These computer-readable program instructions may be provided to a processing unit of a general-purpose computer, a special-purpose computer, or other programmable data processing device to produce a machine, such that the instructions, when executed by a processing unit of a computer or other programmable data processing device, produce means to implement the functions/operations specified in the flowchart and/or block diagram. These computer-readable program instructions may also be stored in a computer-readable storage medium that cause the computer, programmable data processing device, and/or other devices to function in a particular manner, such that the computer-readable medium storing instructions includes an article of manufacture including instructions to implement aspects of the functions/operations specified in the one or more blocks of the flowchart and/or block diagram.

The computer-readable program instructions may be loaded onto a computer, other programmable data processing device, or other devices, such that a series of operational steps are performed on a computer, other programmable data processing device, or other devices to produce a computer-implemented process such that the instructions executed on a computer, other programmable data processing device, or other devices implement the functions/operations specified in one or more blocks of the flowchart and/or block diagram.

The flowchart and block diagram in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagram and/or flowchart, as well as combinations of blocks in the block diagram and/or flowchart, may be implemented with a dedicated hardware-based system that performs the specified functions or operations, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for training a generative model, comprising:
constructing a training prompt; and
performing a plurality of rounds of iterative training based on the training prompt, wherein each round of iterative training comprises:
obtaining a plurality of response contents generated by the generative model based on the training prompt;
determining a first response content and a second response content from the plurality of response contents based on evaluation information of the plurality of response contents, wherein an evaluation of the first response content is superior to an evaluation of the second response content; and
adjusting a parameter of the generative model to increase a first probability of outputting the first response content and reduce a second probability of outputting the second response content.

2. The method of claim 1, wherein constructing the training prompt comprises:
generating the training prompt using the generative model.

3. The method of claim 1, wherein determining the first response content and the second response content from the plurality of response contents based on the evaluation information of the plurality of response contents comprises:
ranking the plurality of response contents based on the evaluation information; and
determining the first response content and the second response content based on a ranking result of the plurality of response contents.

4. The method of claim 1, wherein the first response content is a response content with a best evaluation in the plurality of response contents, and the second response content is a response content with a worst evaluation in the plurality of response contents.

5. The method of claim 1, wherein adjusting the parameter of the generative model comprises:
determining first preference information of the generative model based on the first probability and the second probability;
determining second preference information of a reference model based on a third probability of the reference model outputting the first response content and a fourth probability of the reference model outputting the second response content; and
determining an objective loss based on the first preference information and the second preference information, to adjust the parameter of the generative model.

6. The method of claim 5, wherein determining the objective loss based on the first preference information and the second preference information comprises:
determining difference information based on a difference between the first preference information and the second preference information;
applying a predetermined weight coefficient to the second preference information to determine third preference information; and
determining the objective loss based on the difference information and the third preference information.

7. The method of claim 5, wherein a parameter of the reference model corresponds to an initial parameter of the generative model prior to the plurality of rounds of iterative training.

8. The method of claim 1, wherein the generative model is a language model and the plurality of response contents are text contents.

9. An electronic device, comprising:
at least one processor; and
at least one memory coupled to the at least one processor and storing instructions for execution by the at least one processor, the instructions, when executed by the at least one processor, causing the electronic device to perform operations comprising:
constructing a training prompt; and
performing a plurality of rounds of iterative training based on the training prompt, wherein each round of iterative training comprises:
obtaining a plurality of response contents generated by the generative model based on the training prompt;
determining a first response content and a second response content from the plurality of response contents based on evaluation information of the plurality of response contents, wherein an evaluation of the first response content is superior to an evaluation of the second response content; and
adjusting a parameter of the generative model to increase a first probability of outputting the first response content and reduce a second probability of outputting the second response content.

10. The electronic device of claim 9, wherein constructing the training prompt comprises:
generating the training prompt using the generative model.

11. The electronic device of claim 9, wherein determining the first response content and the second response content from the plurality of response contents based on the evaluation information of the plurality of response contents comprises:
ranking the plurality of response contents based on the evaluation information; and
determining the first response content and the second response content based on a ranking result of the plurality of response contents.

12. The electronic device of claim 9, wherein the first response content is a response content with a best evaluation in the plurality of response contents, and the second response content is a response content with a worst evaluation in the plurality of response contents.

13. The electronic device of claim 9, wherein adjusting the parameter of the generative model comprises:
determining first preference information of the generative model based on the first probability and the second probability;
determining second preference information of a reference model based on a third probability of the reference model outputting the first response content and a fourth probability of the reference model outputting the second response content; and
determining an objective loss based on the first preference information and the second preference information, to adjust the parameter of the generative model.

14. The electronic device of claim 13, wherein determining the objective loss based on the first preference information and the second preference information comprises:
determining difference information based on a difference between the first preference information and the second preference information;
applying a predetermined weight coefficient to the second preference information to determine third preference information; and
determining the objective loss based on the difference information and the third preference information.

15. The electronic device of claim 13, wherein a parameter of the reference model corresponds to an initial parameter of the generative model prior to the plurality of rounds of iterative training.

16. The electronic device of claim 9, wherein the generative model is a language model and the plurality of response contents are text contents.

17. A non-transitory computer-readable storage medium having stored thereon a computer program executable by a processor to perform operations comprising:
constructing a training prompt; and
performing a plurality of rounds of iterative training based on the training prompt, wherein each round of iterative training comprises:
obtaining a plurality of response contents generated by the generative model based on the training prompt;
determining a first response content and a second response content from the plurality of response contents based on evaluation information of the plurality of response contents, wherein an evaluation of the first response content is superior to an evaluation of the second response content; and
adjusting a parameter of the generative model to increase a first probability of outputting the first response content and reduce a second probability of outputting the second response content.

18. The non-transitory computer-readable storage medium of claim 17, wherein constructing the training prompt comprises:
generating the training prompt using the generative model.

19. The non-transitory computer-readable storage medium of claim 17, wherein determining the first response content and the second response content from the plurality of response contents based on the evaluation information of the plurality of response contents comprises:
ranking the plurality of response contents based on the evaluation information; and
determining the first response content and the second response content based on a ranking result of the plurality of response contents.

20. The non-transitory computer-readable storage medium of claim 17, wherein the first response content is a response content with a best evaluation in the plurality of response contents, and the second response content is a response content with a worst evaluation in the plurality of response contents.
